(19) United States
(12) Patent Application Publication
(10) Pub. No.: US 2024/0332583 A1
(43) Pub. Date: Oct. 3, 2024

(54) SYSTEMS AND TECHNIQUES FOR MEMBRANE ELECTRODE ASSEMBLY LAYER APPLICATION

(71) Applicant: Twelve Benefit Corporation, Berkeley, CA (US)

(72) Inventor: Marlene R. Hoeber, Berkeley, CA (US)

(73) Assignee: Twelve Benefit Corporation, Berkeley, CA (US)

(21) Appl. No.: 18/626,161

(22) Filed: Apr. 3, 2024

Related U.S. Application Data
(60) Provisional application No. 63/493,952, filed on Apr. 3, 2023.

(51) Int. Cl. H01M 8/1086; H01M 8/1004

(52) U.S. Cl. CPC H01M 8/1093; H01M 8/1004

(57) ABSTRACT

Clamping devices for securing polymer electrolyte membranes (PEMs) during drying are provided. The clamping devices expose surfaces of the PEMs. The exposed surfaces of the PEMs are sprayed with one or more layers of material while the PEMs are secured by the clamping devices. One or more of the one or more layers of material can include a catalyst.

### RELATED APPLICATION(S)

An Application Data Sheet is filed concurrently with this specification as part of the present application. Each application that the present application claims benefit of or priority to as identified in the concurrently filed Application Data Sheet is incorporated by reference herein in its entirety and for all purposes.

### BACKGROUND

Fuel cells and electrolyzers both utilize components referred to as “membrane electrode assemblies” (MEAs). An MEA typically includes a polymer electrolyte membrane (PEM) that has one or more layers of material applied to one or both sides. Discussed herein are systems and techniques for applying such layer(s) of material to PEMs suitable for use in MEAs.

Background and contextual descriptions contained herein are provided solely for the purpose of generally presenting the context of the disclosure. Much of this disclosure presents work of the inventors, and simply because such work is described in the background section or presented as context elsewhere herein does not mean that such work is admitted prior art.

### SUMMARY

Details of one or more implementations of the subject matter described in this specification are set forth in the accompanying drawings and the description below. Other features, aspects, and advantages will become apparent from the description, the drawings, and the claims.

In some implementations, an apparatus may be provided that includes a plate having a first side and a second side opposite the first side. The plate may define one or more apertures extending from the first side to the second side. One or more resilient seal members may be affixed to the first side of the plate. The one or more resilient seal members may provide a corresponding aperture seal wall around each aperture, the one or more resilient seal members may further provide a perimeter seal wall, and the one or more aperture seal walls may be located within the perimeter seal wall.

In some implementations, for each aperture, a corresponding edge formed where that aperture intersects the second side of the plate may be chamfered.

In some implementations, the one or more apertures may be circular.

In some implementations, the one or more apertures may be rectangular.

In some implementations, the one or more apertures may be square.

In some implementations, each aperture may be sized to be the same size and shape as a layer-receiving region of a corresponding polymer electrolyte membrane.

In some implementations, there may be a plurality of apertures.

In some implementations, the perimeter seal wall and each aperture seal wall may be the same thickness.

In some implementations, the one or more resilient seal members may be made of a polymeric material.

In some implementations, there may be a plurality of resilient seal members, and separate resilient seal members may provide the perimeter seal wall and at least one aperture seal wall.

In some implementations, separate resilient seal members may provide the perimeter seal wall and each aperture seal wall.

In some implementations, separate resilient seal members may provide at least two aperture seal walls.

In some implementations, a first area may be defined, in the case where there is a single resilient seal member, by an area of a surface of the resilient seal member that is furthest from the plate, or, in the case where there are multiple resilient seal members, by a total area of surfaces of the resilient seal members furthest from the plate. A second area may be defined by an outermost perimeter of the one or more resilient seal members that is furthest from the plate, and a third area may be defined, in the case where there is a single aperture, by the area enclosed within the innermost perimeter of the aperture seal wall corresponding thereto, or, in the case where there are multiple apertures, by the sum of the areas enclosed within the innermost perimeters of the aperture seal walls corresponding thereto. A fourth area may be defined by the second area minus the third area, and the fourth area divided by the first area may be greater than or equal to three and a half.

In some implementations, the apparatus may further include a vacuum table, and the plate may be positioned on top of the vacuum table with the one or more resilient seal members interposed between the vacuum table and the plate.

In some implementations, the vacuum table may have a sintered structure.

In some implementations, the vacuum table may have a plurality of machined vacuum ports distributed across a surface facing the plate.

In some implementations, the vacuum table may include, or be connected with, a heater configured to heat the vacuum table.

In some implementations, the apparatus may further include one or more polymer electrolyte membranes (PEMs). Each of the one or more PEMs may be aligned with a corresponding one of the apertures and may have edge regions positioned between the one or more resilient seal members and the vacuum table.

In some such implementations, each of the one or more PEMs may be in a wet, expanded state.

In some implementations, a method may be provided that includes providing any of the apparatuses discussed above, providing a vacuum table (if not already provided), positioning one or more polymer electrolyte membranes (PEMs) on the vacuum table, positioning the plate over the one or more PEMs such that each PEM is located within a corresponding aperture and such that edges of that PEM are overlapped by the aperture seal wall for that corresponding aperture, decreasing a localized pressure at a surface of the vacuum table on which the plate is positioned, decreasing a localized pressure at a surface of the vacuum table, thereby clamping the one or more PEMs against the vacuum table with the plate, and applying a layer of material to each PEM through the aperture for that PEM.

In some implementations, the method may further include soaking the one or more PEMs in liquid in order to cause the one or more PEMs to expand in size prior to clamping the one or more PEMs against the vacuum table and clamping the PEMs when the one or more PEMs are in a wet state.

In some implementations, the method may further include drying the one or more PEMs after clamping the one or more PEMs against the vacuum table and prior to applying the layer of material to the one or more PEMs.

In some implementations, the method may further include heating the one or more PEMs as part of the drying.

The foregoing general description and the following detailed description are illustrative and explanatory and are intended to provide further explanation of the claimed subject matter.

### BRIEF DESCRIPTION OF THE DRAWINGS

Various embodiments disclosed herein are illustrated by way of example, and not by way of limitation, in the figures of the accompanying drawings, in which like reference numerals refer to similar elements.

FIG. 1 depicts a cross-sectional isometric view of a PEM clamping system that includes a plate resting on an example vacuum table.

FIGS. 1′ and 1″ depict detail views of the encircled regions in FIG. 1.

FIG. 2 depicts the plate of FIG. 1 in isolation.

FIG. 3 depicts the plate of FIG. 1 in isolation, as in FIG. 2, but from a reverse perspective.

FIG. 4 depicts an example of a near-functional-equivalent of the plate of FIG. 3 but with a single resilient seal member.

FIG. 5 depicts three views of the plate of FIG. 1 with different areas indicated.

FIG. 6 depicts a set of four PEMs being placed onto a vacuum table with a plate positioned above them.

FIG. 7 depicts the plate and the four PEMs of FIG. 6 with the plate exerting a clamping force on the PEMs due to vacuum being applied to the vacuum table.

FIG. 8 depicts the PEMs of FIG. 7 being subjected to heat while being clamped in order to dry them in preparation for application of a material layer.

FIG. 9 depicts the PEMs of FIG. 8 having a material layer applied thereto.

FIG. 10 depicts the PEMs of FIG. 9 after the plate has been removed.

FIG. 11 depicts the PEMs of FIG. 10 after removal from the vacuum table.

### DETAILED DESCRIPTION OF SOME EMBODIMENTS

As noted earlier, MEAs used in fuel cells and electrolyzers typically feature a PEM that has one or more layers of material applied to one or both sides. Applying a layer or layers of material to a PEM such that the layer(s) of material perform as desired during use may be challenging. For example, fuel cells and electrolyzers are, from the perspective of an MEA, both “wet” environments, i.e., the MEAs that are housed within such devices are constantly exposed to moisture during use. Typical PEMs used in MEAs experience significant in-plane expansion when moving from a dry state of the PEM to a wet state of the PEM. For example, the wet PEM can exhibit up to 20% in-plane dimensional expansion when compared to the dry PEM. Thus, for example, if one applies a layer or layers of material to a PEM when the PEM is in a dry state, when the PEM is subsequently wetted, the PEM may absorb the liquid and expand to a much greater degree than the layer or layers of material that were applied. Such expansion can result in tearing or cracking of the layer or layers of material and/or can result in regions of the PEM that are not covered by the layer or layers of material. In either instance, a reduction in performance and/or a reduction in efficiency can be observed for the fuel cell or electrolyzer when PEM expansion occurs and the layer or layers of material have been applied without taking such potential expansion into account.

To mitigate such issues, a PEM may be soaked in a liquid, e.g., water, prior to application of the layer(s) of material, thereby causing the PEM to expand to its enlarged “wet” size-if the layer(s) of material is/are applied when the PEM is in this enlarged state, then issues such as the above-discussed problems may be avoided or mitigated. However, the layer(s) of material typically cannot be applied until the PEM is dry, at which point the PEM will generally shrink back to its pre-wet size. However, if the PEM is mechanically restrained while drying so that it maintains its wet size (or stays near to the wet size) even after drying out, this allows the layer(s) of material to be applied to a dry PEM that is at or near the size that the PEM would be at when wet. This reduces the potential for tearing or cracking of the material layer(s) when the PEM is later re-hydrated and expands back into its wet size.

The present disclosure provides for a PEM clamping system that utilizes a plate with a first side and a second side opposite the first side. The clamping system may be designed to allow for one or more PEMs to be clamped in place by the plate. Each such PEM would have a region on a side of interest that is intended to have one or more layers of material applied thereto. The plate would correspondingly also include one or more apertures through it extending from the first side to the second side. Each aperture, for example, would be the same shape and size as a corresponding one of the layer-receiving regions, and each aperture would be located so as to align with one of the PEMs. Such a plate may, when used in conjunction with a vacuum table and, optionally, a heater, be used to clamp wet PEMs against the vacuum table (the clamping force may be provided by the vacuum suction drawn by the vacuum table, e.g., such suction may be used to decrease a localized pressure at a surface of the vacuum table, thereby generating a pressure differential between one side of the plate and the other and causing atmospheric pressure to press the plate against the vacuum table), thereby securing the PEMs in place relative to the plate and vacuum table while the PEMs dry. One or more layers of material may then be applied, e.g., via spraying or other deposition technique, to the region(s) of the PEM(s) exposed through the one or more apertures (once the PEM(s) are dry or sufficiently dry enough to receive such application of one or more layers of material). In various examples, one or more of the one or more layer(s) of material can include a catalyst. Additionally, or alternatively, one or more of the one or more layer(s) can include a material used to provide all or part of an anion exchange membrane (AEM).

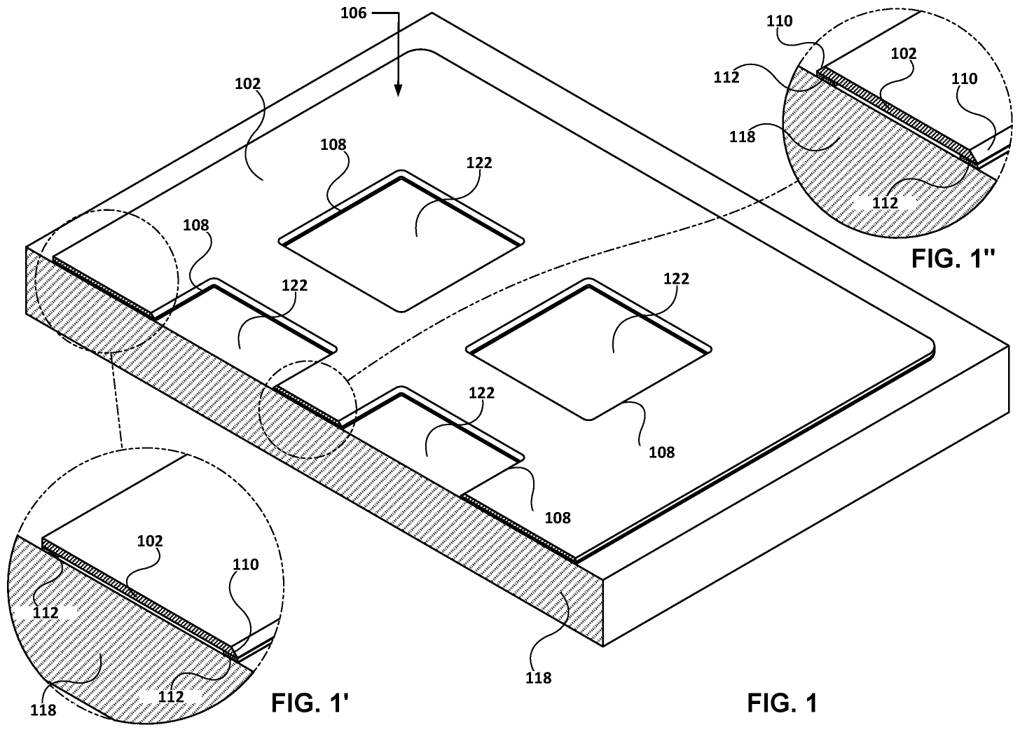

FIG. 1 depicts a cross-sectional isometric view of an example plate 102 resting on an example vacuum table 118. FIGS. 1′ and 1″ depict detail views of the encircled regions in FIG. 1.

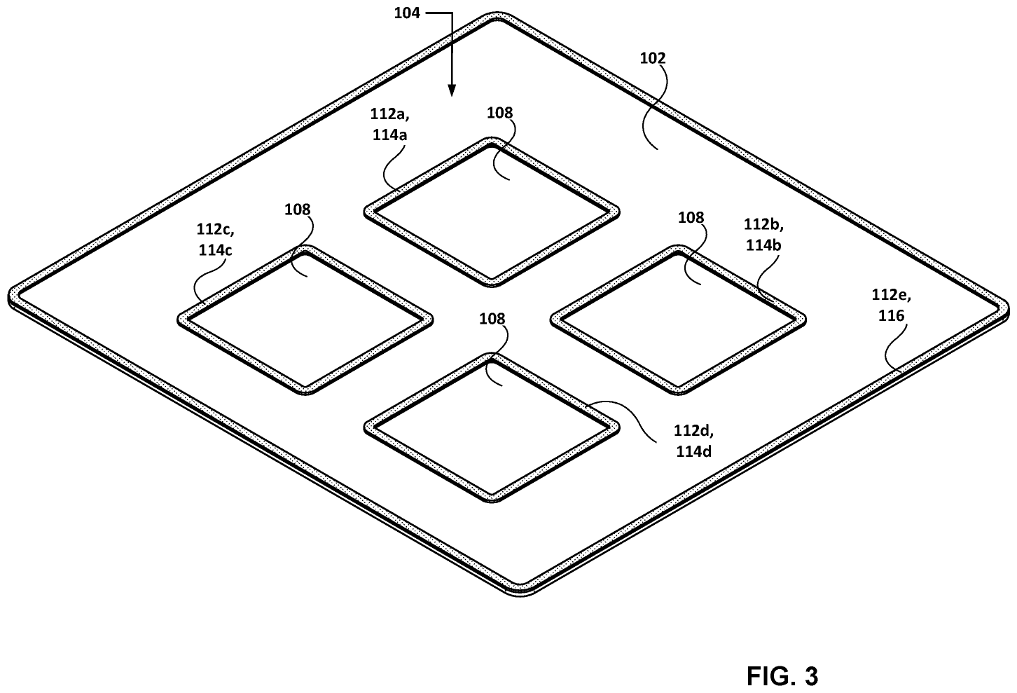

The plate 102 may be made of steel, aluminum, or other high-modulus material that allows the plate 102 to withstand an atmospheric pressure differential without significant flexure. As can be seen, the plate 102 may be relatively thin. For example, and without limitation, the plate 102 may have a thickness that is about one eighth of an inch to about one quarter of an inch. The plate 102 may be other thicknesses as well. A first side 104 (see FIG. 3) of the plate 102 is oriented toward a top surface of the vacuum table 118 when in use. A second side 106 of the plate 102 opposes the first side 104 and is oriented away from the top surface of the vacuum table 118 when in use. One or more apertures 108 may extend through the plate 102 from the first side 104 to the second side 106. As shown in FIG. 1, the plate 102 is resting on top of a vacuum table 118 with a plurality of PEMs 122 interposed between the plate 102 and the vacuum table 118. The PEMs 122 may be made of any suitable material, e.g., various Nafion® formulations (such as Nafion® 115, 117, or 211), GORE-SELECT, FumaPEM® (PFSA) (FuMA-Tech GmbH), or Aquivion® (PFSA) (Solvay).

The vacuum table 118 may, for example, be any flat surface with one or more openings or vacuum ports defined therein that may be used to draw a vacuum. For example, the vacuum table 118 may be a large, flat platen with a large array of small, drilled vacuum ports that are connected with an internal manifold within the platen that leads to a vacuum pump, thereby allowing the vacuum pump to draw gas into the platen via the vacuum ports when operating. In another example, the vacuum table 118 may be a sintered structure connected with a plenum on the underside that is in fluidic communication with a vacuum pump, thereby allowing the vacuum pump to draw gas through interstices in the sintered structure of the vacuum table 118 when operated.

The first side 104 of the plate 102 may have one or more resilient seal members 112 affixed thereto. The one or more resilient seal members 112 may form, for example, one or more aperture seal walls 114, as well as a perimeter seal wall 116. The one or more resilient seal members 112 may, for example, be provided using a compressible polymeric material having a relatively high coefficient of friction, e.g., neoprene rubber, silicone, etc. In some cases, the one or more resilient seal members 112 may be provided using rubber or silicone adhesive-backed gasket material that is cut into the shapes of the one or more aperture seal walls 114 and the perimeter seal wall 116. For example, the one or more resilient seal members 112 may be cut from one sixteenth of an inch thick rubber gasket material that may then be adhered, e.g., using pressure-sensitive adhesive or a curable adhesive, to the first side 104 of the plate 102. The one or more resilient seal members 112 may have other thicknesses as well, e.g., one eighth of an inch thick, one thirty-second of an inch thick, etc., without departing from the concepts discussed herein. However, it is noted that the risk of shadowing issues (see later discussion) may increase with increasing thickness of the one or more resilient seal members 112. Conversely, the risk of the plate 102 coming directly into contact with the vacuum table 118 (thereby undesirably reducing the clamping pressure on the PEMs) may increase if the one or more resilient seal members 112 are made too thin, e.g., such that the deflection of the plate 102 under vacuum loading exceeds the thickness of the one or more resilient seal members 112.

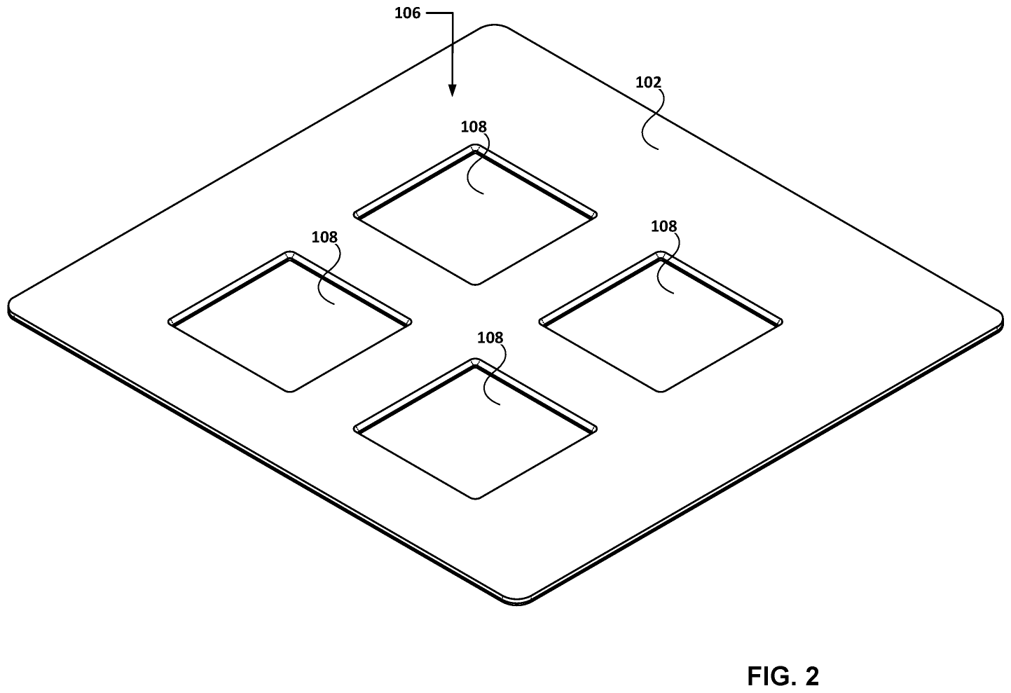

FIG. 2 depicts the plate 102 in isolation, without the PEMs 122 or the vacuum table 118. FIG. 3 depicts the plate 102 in isolation, as in FIG. 2, but from a reverse perspective. As can be seen in FIG. 3, the first side 104 of the plate 102 has affixed to it five resilient seal members 112—resilient seal members 112a-d encircling the four apertures 108, and a fifth resilient seal member 112e extending along the exterior edge of the plate 102. The resilient seal members 112a-d form respective aperture seal walls 114a-d, while the resilient seal member 112e forms a perimeter seal wall 116 around the perimeter of the plate 102 (such that the aperture seal walls 114a-d are located within the perimeter seal wall 116).

The aperture seal walls 114a-d and the perimeter seal wall 116, in effect, serve as raised walls that extend around the edges of the apertures 108 and the outer perimeter of the plate 102. A thickness of the aperture seal walls 114a-d and a thickness of the perimeter seal wall 116 may be the same, or nearly the same. When the plate 102 is placed on top of the vacuum table 118 with the first side 104 facing towards the vacuum table 118, the aperture seal walls 114a-d and the perimeter seal wall 116 support the plate 102 above the vacuum table 118, resulting in a small gap between the vacuum table 118 and the first side 104 of the plate 102. The air that is trapped within this gap has no vent path except through the vacuum table 118, as the aperture seal walls 114a-d and the perimeter seal wall 116 provide a seal against the vacuum table 118.

When a vacuum is drawn on the plate 102 by the vacuum table 118, the gas that is trapped between the plate 102, the vacuum table 118, the perimeter seal wall 116, and the aperture seal walls 114 may be evacuated to form a vacuum or partial vacuum in between the plate 102 and the vacuum table 118. Accordingly, the atmospheric pressure on the plate 102 may exert a significant clamping force on the plate 102. For example, a plate 102 having a first side 104 with a total surface area of about 240 square inches may experience 3500 pounds of clamping force when the first side 104 is subjected to a vacuum. If the surface area(s) of the surface or surfaces of the one or more resilient members 112 in contact with the plate #102 are designed to be much smaller than the total surface area of the first side 104 of the plate 102, when such a load is then transmitted to the vacuum table 118 via the one or more resilient seal members 112, the pressure exerted by the one or more resilient seal members 112 on the vacuum table 118 may be much higher than atmospheric pressure. For example, the depicted resilient seal members 112 may be one quarter of an inch in transverse width (i.e., a dimension of the resilient seal members 112 that is parallel to the first side 104 and perpendicular to the path followed by the resilient seal member at the point where the dimension is evaluated). For a plate 102 that is approximately 18 inches wide and 17 inches long with four 4 inch square apertures 108 defined therein, using resilient seal members 112 that are approximately one quarter of an inch in width may cause the 3500 pounds of force exerted on the plate 102 to be transferred to the vacuum table 118 plate 102 via much smaller contact regions. In such an example, the 3500 pounds of force can be transferred to the vacuum table 118 along contact regions that are on the order of 17 square inches for the perimeter seal wall 116 and another 17 square inches for the four aperture seal walls 114 (in total). The pressure exerted on the vacuum table 118 by the one or more resilient members 112 in such an example may be approximately 100 psi-considerably higher than atmospheric pressure.

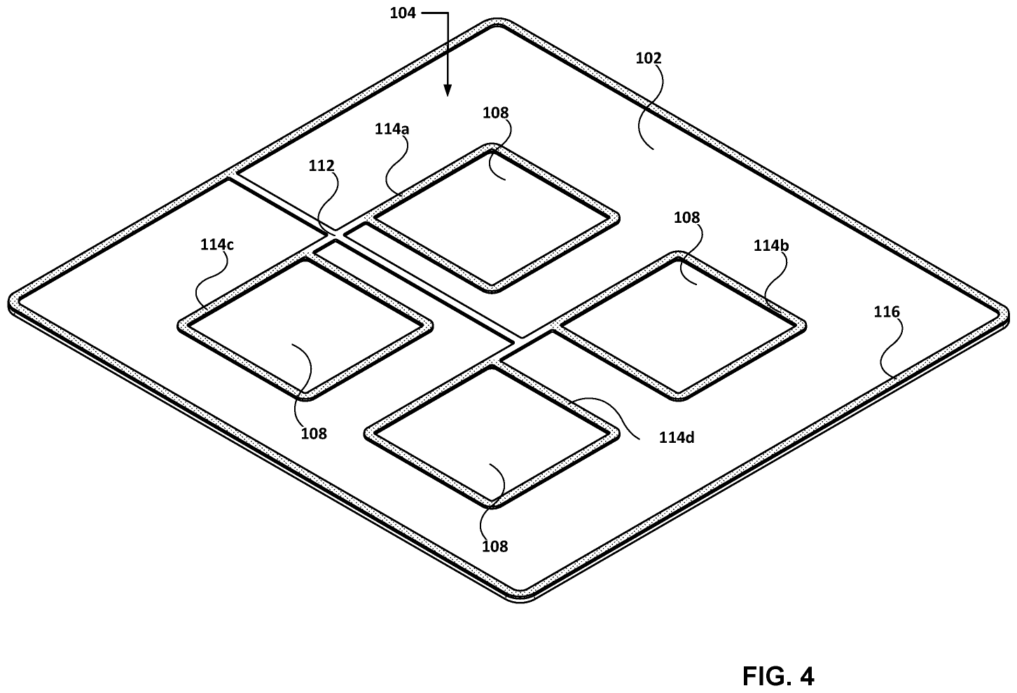

It will be appreciated that the one or more resilient seal members 112 may be provided as a single piece. FIG. 4 depicts an example of a near-functional-equivalent of the embodiment of FIG. 3 that demonstrates such an approach. In this example, the aperture seal walls 114a-d and the perimeter seal wall 116 are portions of a single, contiguous resilient seal member 112 that has portions that extend around the outer perimeter of the plate 102 and around the apertures 108, all of which are joined to a “spine” of the resilient seal member that extends towards the center of the plate 102 from an edge of the perimeter seal wall 116. In other implementations, there may be a plurality of resilient seal members 112, with at least one resilient seal member 112 used to provide the perimeter seal wall 116 and at least one other resilient seal member 112 used to provide at least one aperture seal wall 114. In some implementations, there may be a plurality of resilient seal members 112, with at least one resilient seal member 112 used to provide at least one aperture seal wall 114 and at least one other resilient seal member 112 used to provide at least one other aperture seal wall 114.

Designs that provide the one or more resilient seal members 112 as a single piece would provide slightly less clamping pressure than the design shown in FIG. 3 but would nonetheless be nearly equivalent in performance. It will be generally appreciated that reducing the transverse widths of the aperture seal walls 114a-d and the perimeter seal wall 116 will generally act to increase the clamping pressure exerted by the one or more resilient seal members 112 on the vacuum table 118, as well as anything that is clamped between the vacuum table 118 and the plate 102. However, reducing the transverse width of the aperture seal walls 114a-d and the perimeter seal wall 116 also reduces the amount of friction that the surfaces of the one or more resilient seal members 112 furthest from the plate 102 can exert on items, e.g., the PEMs 122, clamped between the plate 102 and the vacuum table 118. When the plate 102 is used to clamp a structure, such as the PEMs 122, with the intent of preventing transverse movement of the clamped structure, the friction force exerted on the clamped portions of such structures needs to be sufficient to overcome the transverse loading applied to the clamped portions of the structures. For example, if the clamped structure is a wet PEM 122, the friction force developed on the clamped portions of the wet PEM 122 need to be high enough to withstand the tensile forces that may arise within the PEM 122 as it dries out and tries to return to its “dry” dimensional state.

It was found in practice that transverse widths for the aperture seal walls 114a-d and the perimeter seal wall 116 on the order of one quarter of an inch in a plate, such as the example above, provided sufficient clamping force to secure square PEMs that were approximately 4 inches on a side. In some implementations, a relationship may be defined between two areas-one area, which may be generally defined by the area (or sum of areas) of the surface(s) of the one or more resilient seal members 112 that are furthest from the plate 102, and another area, which may be generally defined as the area bounded between the outermost perimeter of the perimeter seal wall 116 and the innermost perimeter(s) of the aperture seal walls 114.

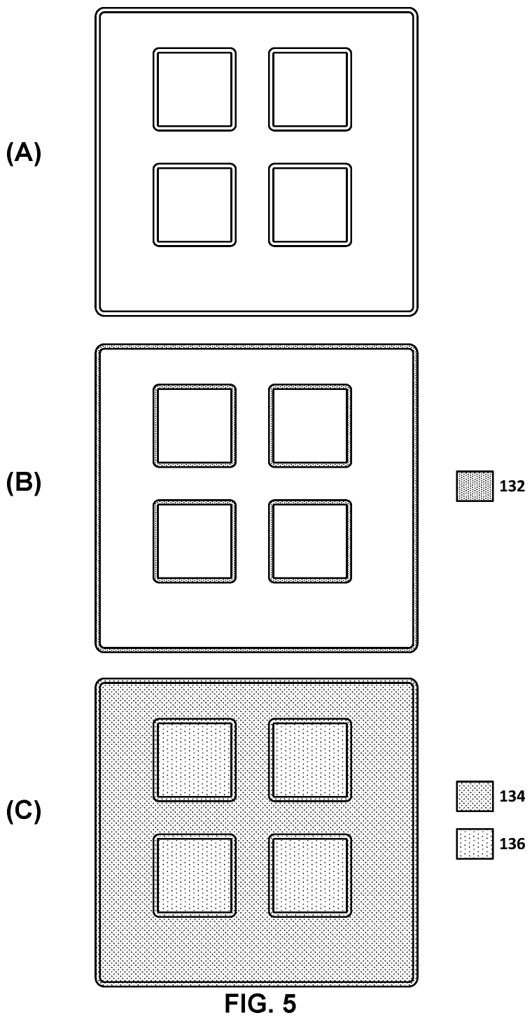

FIG. 5 depicts three views of the first side 104 of the plate 102 to illustrate the above. In the first view (A), the first side 104 of the plate 102 is shown with the one or more resilient seal members 112. In the second view (B), a first area 132 is shown using shading. As can be seen, the first area 132 includes the bottom surfaces of the aperture seal walls 114a-d and the perimeter seal wall 116; these surfaces are the ones furthest from the plate 102. The first area 132 does not include the regions within the aperture seal walls 114a-d or the region in between the aperture seal walls 114a-d and the perimeter seal wall 116.

In the third view (C), a second area 134 and a third area 136 are shown as shaded regions. The second area 134 is defined by an outermost perimeter of the one or more resilient seal members 112 that is furthest from the plate, e.g., by the outer perimeter of the perimeter seal wall 116. Somewhat analogously, the third area 136 is defined, in the case where there is a single aperture 108, by the area enclosed within the innermost perimeter of the aperture seal wall 114 corresponding thereto, or, in the case where there are multiple apertures 108 (such as shown in FIG. 5), by the sum of the areas enclosed within the innermost perimeters of the aperture seal walls 114 corresponding thereto. A fourth area may be defined by subtracting the third area from the second area. In the case where the perimeter seal wall 116 is flush with the outermost edges of the plate 102 and the aperture seal wall(s) 114 is/are flush with the innermost edge(s) of the apertures 108, the fourth area may, for example, generally be equal to the surface area of the first side of the plate 102.

In some implementations, the fourth area divided by the first area may be greater than or equal to three and a half. In some implementations, fourth area divided by the first area may be greater than or equal to seven; such implementations may provide a sufficient amount of clamping pressure on the PEMs 122 that may be clamped between the plate 102 and the vacuum table 118, e.g., on the order of 100 psi or more of clamping pressure.

It will be appreciated that the plate 102 shown above may be implemented with a single aperture 108 or with multiple apertures 108 (as shown). Generally speaking, the number of apertures 108 that may be included in the plate 102 may be dependent on the size of the plate 102, the size and shapes of the apertures 108, and the amount of clamping pressure that is desired. For example, the number of apertures 108 that may be included in the plate 102 may be dependent on the size of the plate 102, the size and shapes of the apertures 108, and the relationship between the first area and the fourth area discussed above. The apertures 108, if multiple apertures 108 are present in a plate 102, may be distributed across the area of the plate 102 in a pattern or array. For example, the apertures 108 may define a rectangular pattern, a circular pattern, or any other pattern.

It will be further appreciated that the apertures 108 may, as shown, be rectangular or square in shape, but such apertures 108 may also take other shapes, such as circular shapes. Each aperture 108 will generally be the same size and shape as a layer-receiving region 124 on a PEM 122. The layer-receiving region 124 on the PEM 122 may be sized larger than the aperture 108. It is contemplated that, in some examples, the layer-receiving region 124 on the PEM 122 may be sized larger than the aperture 108 when the PEM 122 is in the wet state, whereas such relationship may not exist when the PEM 122 is in the dry state. The layer-receiving region(s) 124 may, for example, have a first dimension along a first axis and a second dimension along a second axis orthogonal to the first axis. The first and second dimensions, for example, may each have a value that is between about 1 inch and about 36 inches, between about 1 inch and about 18 inches, between about 18 inches and about 36 inches, between about 1 inch and about 9.8 inches, between about 9.8 inches and about 18 inches, between about 18 inches and about 27 inches, between about 27 inches and about 36 inches, between about 1 inch and about 5.4 inches, between about 5.4 inches and about 9.8 inches, between about 9.8 inches and about 14 inches, between about 14 inches and about 18 inches, between about 18 inches and about 23 inches, between about 23 inches and about 27 inches, between about 27 inches and about 32 inches, between about 32 inches and about 36 inches, between about 1 inch and about 3.2 inches, between about 3.2 inches and about 5.4 inches, between about 5.4 inches and about 7.6 inches, between about 7.6 inches and about 9.8 inches, between about 9.8 inches and about 12 inches, between about 12 inches and about 14 inches, between about 14 inches and about 16 inches, between about 16 inches and about 18 inches, between about 18 inches and about 21 inches, between about 21 inches and about 23 inches, between about 23 inches and about 25 inches, between about 25 inches and about 27 inches, between about 27 inches and about 29 inches, between about 29 inches and about 32 inches, between about 32 inches and about 34 inches, or between about 34 inches and about 36 inches.

In some implementations, the edge formed where each aperture 108 intersects the second side 106 of the plate 102 may be chamfered or beveled, e.g., as shown by chamfers 110 in FIGS. 1′ and 1″. As shown, the chamfers 110 are 45° chamfers, although shallower or steeper chamfers may be used as well. The chamfers 110, if used, reduce the potential for “shadowing” of the edges of the layer-receiving region 124 during application of the layer(s) of material. “Shadowing” of the edges of the layer-receiving region 124 references a circumstance where a decreased amount, or density, of the layer of material is deposited at the edges of the layer-receiving region 124 as compared with the interior of the layer-receiving region 124. In the depicted example of FIGS. 1′ and 1″, the chamfers 110 extend through nearly the entire thickness of the plate 102, e.g., coming within one one-hundredth of an inch of the first side 104 of the plate 102. However, other chamfer-including implementations may feature chamfers 110 that extend to shallower depths in the plate 102.

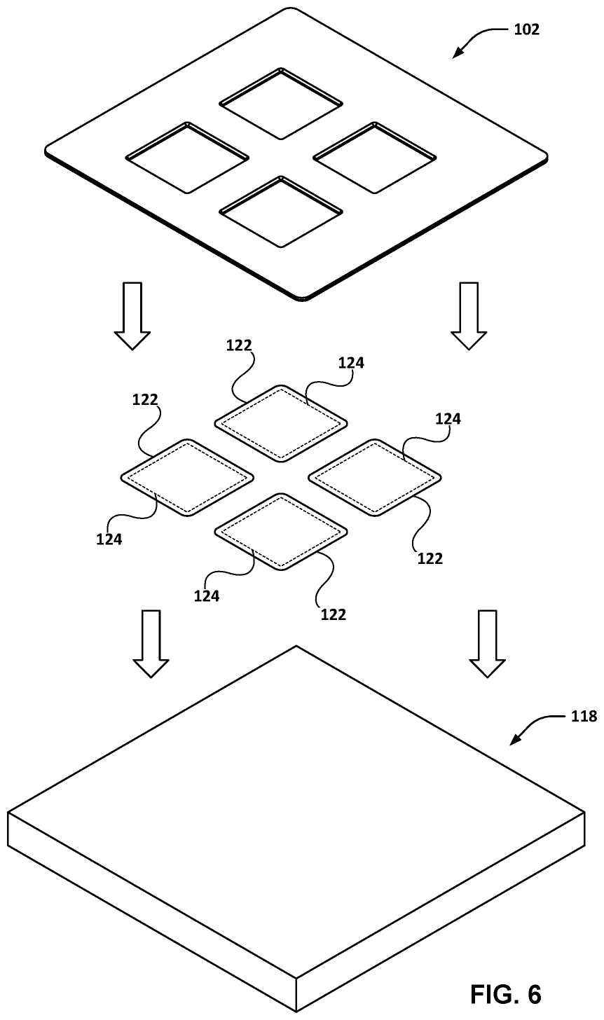

FIGS. 6 through 11 depict various stages in the use of the clamping system discussed above. In FIG. 6, a set of four PEMs 122 are placed onto the vacuum table 118; each PEM 122 has a layer-receiving region 124 associated therewith. The layer-receiving regions 124 are shown in dotted lines but may not be physically evident on the PEMs 122. The PEMs 122 may be soaked in liquid, e.g., water, prior to being placed onto the vacuum table 118 so that they are in their wet, expanded, state when placed on the vacuum table 118. The vacuum table 118 may, for example, have markings or other graphical indicators on it that may mark where the PEMs 122 are to be placed such that the PEMs 122 are arranged on the vacuum table 118 in the same manner that the apertures 108 are arranged in the plate 102. The plate 102 may then be placed on top of the PEMs 122 and the vacuum table 118, taking care to ensure that each PEM 122 is positioned within a corresponding aperture 108 of the plate 102 and such that the outer perimeter of each PEM 122 is interposed between the vacuum table 118 and the plate 102.

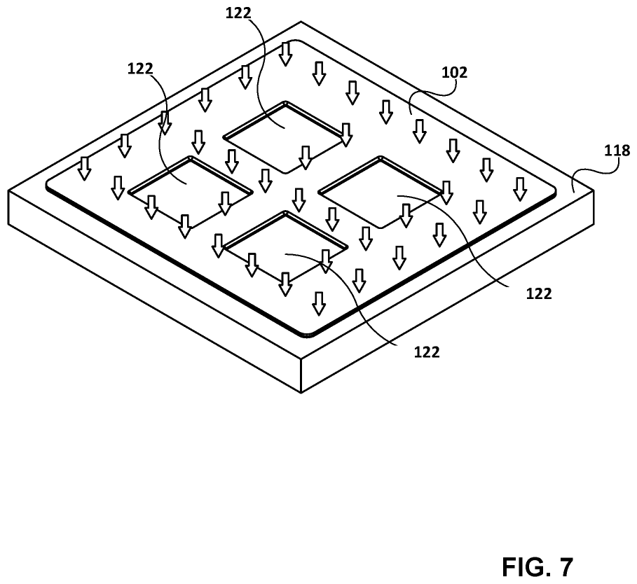

In FIG. 7, a vacuum may be drawn on the vacuum table 118, e.g., using a vacuum pump, thereby creating a pressure differential between the first side 104 of the plate 102 and the second side 106 of the plate 102. This pressure differential results in the plate 102 being pressed toward the vacuum table 118 and pressed against the edges of the PEMs 122, as discussed earlier. The PEMs 122 may also be drawn flat against the vacuum table 118 by the same pressure differential.

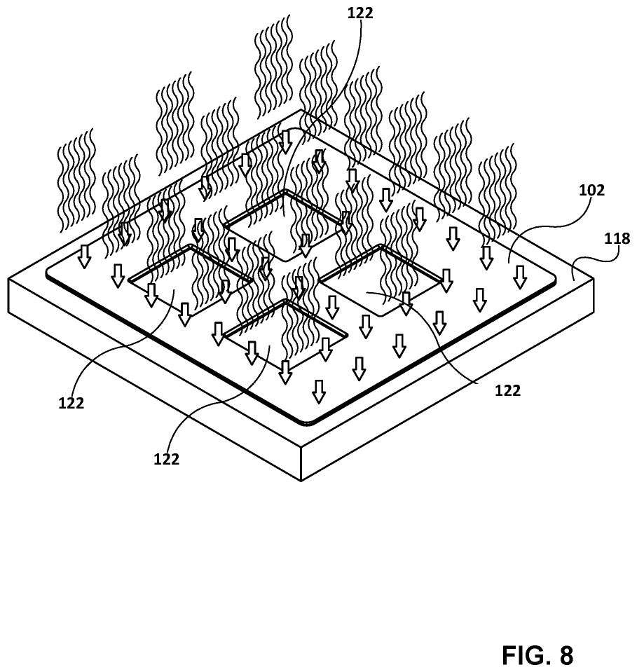

Once the wet PEMs 122 are clamped between the vacuum table 118 and the plate 102 through the application of vacuum to the vacuum table 118, the PEMs 122 may be allowed to dry, e.g., as represented in FIG. 8, so that one or more layers of material may be applied to the PEMs 122. The PEMs 122 may simply be air-dried or, in some implementations, actively heated in order to accelerate the drying. For example, the vacuum table 118 may be positioned atop a heating platen (not shown) that may be used to heat the vacuum table 118 and promote evaporation of moisture that may be resident in the PEMs 122. The clamping force applied to the edges of the PEMs 122 by the plate 102 and the one or more resilient seal members 112 may constrain the PEMs 122 and prevent them from contracting back to their “dry” size, resulting in dry PEMs 122 that are stretched to approximately the same size as the wet PEMs 122.

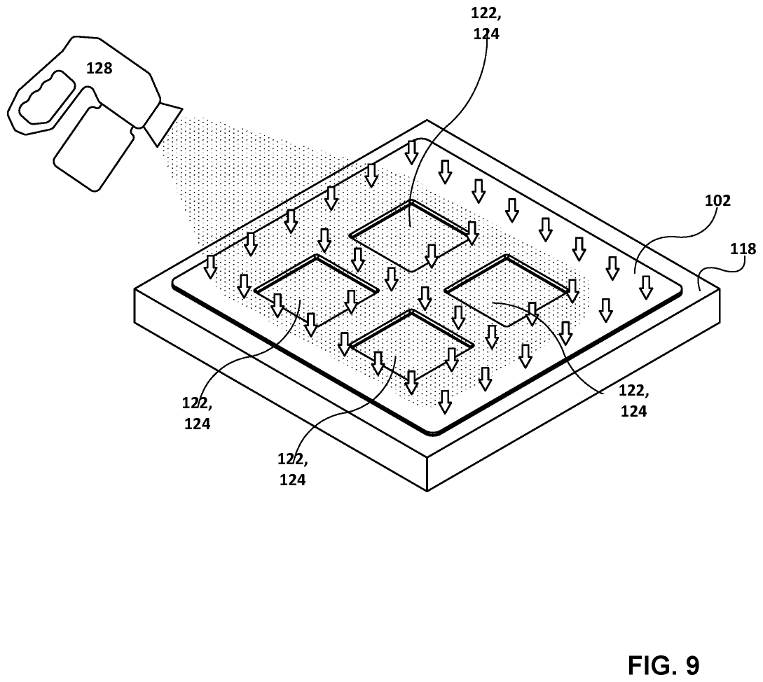

As shown in FIG. 9, once the PEMs 122 are sufficiently dry, one or more layers of material may be applied to the layer-receiving regions 124 that are exposed through the apertures 108, e.g., with a sprayer 128, while the vacuum is maintained on the vacuum table 118. Other techniques and systems for applying a layer of material to the layer-receiving regions 124 may be employed to similar effect in other implementations. In some implementations, heat may be applied (or continue to be applied) to the PEMs 122 during the application of the material layer(s). This may assist with evaporating a solvent that may be used as a carrier for the material. In examples that include a catalyst as one or more of the one or more layers of material, the catalyst(s) may be provided, for example, in the form of sprayable inks. In such examples, the sprayable inks may contain materials such as palladium, nickel, platinum, ruthenium, gold, iridium, iron, manganese, and/or alloys thereof. Such ink formulations may also, for example, include combinations of two or more such materials.

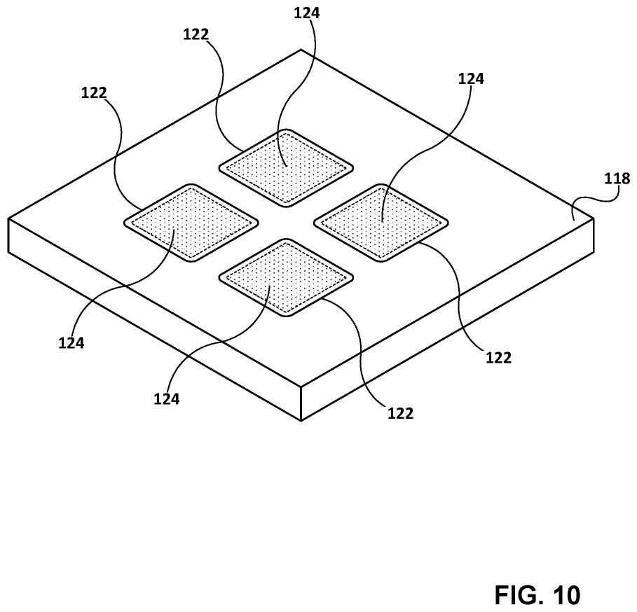

After the layer(s) of material 126 has/have been applied to the PEMs 122 and, if necessary, been provided time to dry or cure, the vacuum applied to the vacuum table 118 may be turned off or disengaged, thereby allowing the pressure differential between the first side 104 and the second side 106 of the plate 102 to return to equilibrium. The plate 102 may then be removed from the vacuum table 118, leaving the PEMs 122 with the layer(s) of material 126 applied to the layer-receiving regions 124 behind, as shown in FIG. 10.

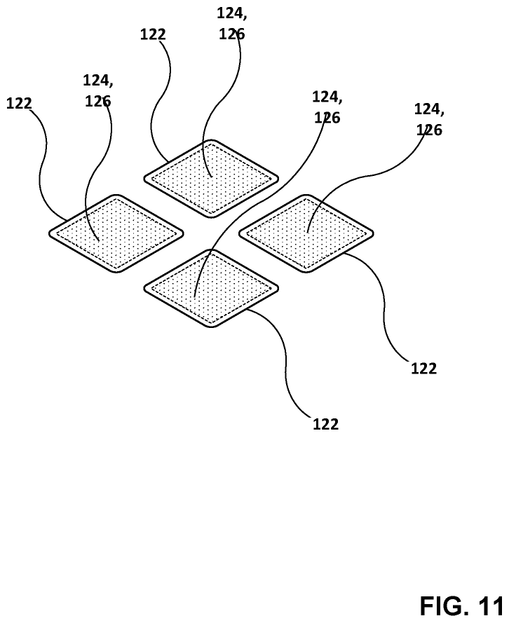

The PEMs 122 with applied layer(s) of material 126 may then be removed from the vacuum table 118, as shown in FIG. 11. In some implementations, the PEMs 122 may, for example, then be flipped over and subjected to a similar process in order to apply one or more layers of material on the opposite side. In some further or alternate implementations, the PEMs 122 may be subjected to further processing operations, e.g., installation into a fuel cell or electrolyzer cell, lamination into a gasket frame, etc., after the layer(s) of material have been applied.

For the purposes of this disclosure, “at least one of X, Y, . . . , and Z” and “at least one selected from the group consisting of X, Y, . . . , and Z” may be construed as X only, Y only, . . . , Z only, or any combination of two or more of X, Y, . . . , and Z, such as, for instance, XYZ, XYY, YZ, and ZZ. As used herein, the term “and/or” includes any and all combinations of one or more of the associated listed items.

Although the terms “first,” “second,” “third,” etc., may be used herein to describe various elements, these elements should not be limited by these terms. These terms are used to distinguish one element from another element. Thus, a first element discussed below could be termed a second element without departing from the teachings of the disclosure. To this end, use of such identifiers, e.g., “a first element,” should not be read as suggesting, implicitly or inherently, that there is necessarily another instance, e.g., “a second element.” Further, the use, if any, of ordinal indicators, such as (a), (b), (c), . . . , or (1), (2), (3), . . . , or the like, in this disclosure and accompanying claims, is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated), unless indicated otherwise. For example, if step (ii) involves the handling of an element that is created in step (i), then step (ii) may be viewed as happening at some point after step (i). In a similar manner, if step (i) involves the handling of an element that is created in step (ii), the reverse is to be understood.

The term “between,” as used herein and when used with a range of values, is to be understood, unless otherwise indicated, as being inclusive of the start and end values of that range. For example, between 1 and 5 is to be understood as inclusive of the numbers 1, 2, 3, 4, and 5, not just the numbers 2, 3, and 4.

As used herein, the singular forms, “a,” “an,” and “the” are intended to include the plural forms as well, unless the context clearly indicates otherwise. It is also to be understood that the phrases “for each <item> of the one or more <items>,” “each <item> of the one or more <items>,” and/or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite dictionary definitions of “each” frequently defining the term to refer to “every one of two or more things”) and would not imply that there must be at least two of those items. Similarly, the term “set” or “subset” should not be viewed, in itself, as necessarily encompassing a plurality of items—it is to be understood that a set or a subset can encompass only one member or multiple members (unless the context indicates otherwise). In addition, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatuses of the disclosed embodiments. Accordingly, embodiments are to be considered as illustrative and not as restrictive, and embodiments are not to be limited to the details given herein. To this end, it should be appreciated that all combinations of the foregoing concepts (provided such concepts are not mutually inconsistent) are contemplated as being part of the inventive subject matter disclosed herein. In particular, all combinations of claimed subject matter appearing at the end of this disclosure are contemplated as being part of the subject matter disclosed herein. It should also be appreciated that terminology explicitly employed herein that also may appear in any disclosure incorporated by reference should be accorded a meaning most consistent with the particular concepts disclosed herein.

It is to be further understood that the above disclosure, while focusing on a particular example implementation or implementations, is not limited to only the discussed example, but may also apply to similar variants and mechanisms as well, and such similar variants and mechanisms are also considered to be within the scope of this disclosure.

What is claimed is:

1. An apparatus comprising:
a plate having a first side and a second side opposite the first side, wherein the plate defines one or more apertures extending from the first side to the second side; and
one or more resilient seal members affixed to the first side of the plate, wherein:
the one or more resilient seal members provide a corresponding aperture seal wall around each aperture,
the one or more resilient seal members further provide a perimeter seal wall, and
the one or more aperture seal walls are located within the perimeter seal wall.

2. The apparatus of claim 1, wherein, for each aperture, a corresponding edge formed where that aperture intersects the second side of the plate is chamfered.

3. The apparatus of claim 1, wherein the one or more apertures are circular, rectangular, or square.

4. The apparatus of claim 1, wherein each aperture is sized to be the same size and shape as a layer-receiving region of a corresponding polymer electrolyte membrane.

5. The apparatus of claim 1, wherein there is a plurality of apertures.

6. The apparatus of claim 1, wherein the perimeter seal wall and each aperture seal wall are the same thickness.

7. The apparatus of claim 1, wherein the one or more resilient seal members are made of a polymeric material.

8. The apparatus of claim 7, wherein there are a plurality of resilient seal members, and wherein separate resilient seal members provide the perimeter seal wall and at least one aperture seal wall.

9. The apparatus of claim 8, wherein separate resilient seal members provide the perimeter seal wall and each aperture seal wall.

10. The apparatus of claim 8, wherein separate resilient seal members provide at least two aperture seal walls.

11. The apparatus of claim 1, wherein:
a first area is defined, in the case where there is a single resilient seal member, by an area of a surface of the resilient seal member that is furthest from the plate, or, in the case where there are multiple resilient seal members, by a total area of surfaces of the resilient seal members furthest from the plate,
a second area is defined by an outermost perimeter of the one or more resilient seal members that is furthest from the plate,
a third area is defined, in the case where there is a single aperture, by the area enclosed within the innermost perimeter of the aperture seal wall corresponding thereto, or, in the case where there are multiple apertures, by the sum of the areas enclosed within the innermost perimeters of the aperture seal walls corresponding thereto,
a fourth area is defined by the second area minus the third area, and
the fourth area divided by the first area is greater than or equal to three and a half.

12. The apparatus of claim 1, further comprising a vacuum table, wherein:
the plate is positioned on top of the vacuum table with the one or more resilient seal members interposed between the vacuum table and the plate.

13. The apparatus of claim 12, wherein the vacuum table has a sintered structure or a plurality of machine vacuum ports distributed across a surface facing the plate.

14. The apparatus of claim 12, wherein the vacuum table includes, or is connected with, a heater configured to heat the vacuum table.

15. The apparatus of claim 12, further comprising one or more polymer electrolyte membranes (PEMs), wherein each of the one or more PEMs is aligned with a corresponding one of the apertures and has edge regions positioned between the one or more resilient seal members and the vacuum table.

16. The apparatus of claim 15, wherein each of the one or more PEMs is in a wet, expanded state.

17. A method, the method comprising:
providing the apparatus of claim 1;
providing a vacuum table;
positioning one or more polymer electrolyte membranes (PEMs) on the vacuum table;
positioning the plate over the one or more PEMs such that each PEM is located within a corresponding aperture and such that edges of that PEM are overlapped by the aperture seal wall for that corresponding aperture;
decreasing a localized pressure at a surface of the vacuum table on which the plate is positioned, thereby clamping the one or more PEMs against the vacuum table with the plate; and
applying a layer of material to each PEM through the aperture for that PEM.

18. The method of claim 17, further comprising soaking the one or more PEMs in liquid in order to cause the one or more PEMs to expand in size prior to clamping the one or more PEMs against the vacuum table, wherein the clamping is initiated with the one or more PEMs in a wet state.

19. The method of claim 18, further comprising drying the one or more PEMs after clamping the one or more PEMs against the vacuum table and prior to applying the layer of material to the one or more PEMs.

20. The method of claim 19, further comprising heating the one or more PEMs as part of the drying.
